(19) United States
(12) Patent Application Publication
(10) Pub. No.: US 2012/0188373 A1
(43) Pub. Date: Jul. 26, 2012

(54) METHOD FOR REMOVING NOISE AND NIGHT-VISION SYSTEM USING THE SAME

(75) Inventors: Taehyeon KWON, Gyeonggi-do (KR); Intaek SONG, Gyeonggi-do (KR); Gyuwon KIM, Gyeonggi-do (KR); Hoseop JEONG, Gyeonggi-do (KR); Kyoungjoong MIN, Seoul (KR)

(73) Assignee: SAMSUNG ELECTRO-MECHANICS CO., LTD., Gyunggi-do (KR)

(21) Appl. No.: 13/107,481

(22) Filed: May 13, 2011

(30) Foreign Application Priority Data
Jan. 21, 2011 (KR) 10-2011-0006323

(51) Int. Cl. H04N 7/18; G06K 9/48; G06K 9/34

(52) U.S. Cl. 348/148; 382/173; 382/199; 348/E07.085

(57) ABSTRACT

Disclosed herein are a method for removing noise by segmenting an image according to a brightness value of the image and/or distribution of pixel data, setting coefficient values of a low pass filter in consideration of characteristics of each image with respect to each segmented image and then filtering each segmented image, and a night vision system including noise removing units using the same disposed before and behind a brightness improving unit, thereby making it possible to remove noise without deteriorating image quality.

### CROSS REFERENCE(S) TO RELATED APPLICATIONS

This application claims the benefit under 35 U.S.C. Section 119 of Korean Patent Application Serial No. 10-2011-0006323, entitled “Method For Removing Noise And Night-Vision System Using The Same” filed on Jan. 21, 2011, which is hereby incorporated by reference in its entirety into this application.

### BACKGROUND OF THE INVENTION

1. Technical Field

The present invention relates to a method for removing noise and a night-vision system using the same, and more particularly, to a method for removing noise in which noise is adaptively removed according to characteristics of an image, and a night-vision system using the same.

2. Description of the Related Art

In a recent automobile technology, in order to improve convenience and stability of a driver during driving of a vehicle, various systems capable of confirming an image through a display of an instrument panel in front of a driver seat by mounting cameras on the left and right sides of the vehicle as well as the front and rear sides thereof have been developed and have already started to be applied to the vehicles. A night vision system (NVS), which is one of these systems, is a device that assists in a field of view of the driver during the driving of the vehicle in a dark environment such as night driving. The night vision system radiates infrared rays to the front side of the vehicle and photographs the front side using a camera to provide an image of the front side to the driver, such that the driver may sense an obstacle or a pedestrian at the front side of the vehicle, thereby making it possible to induce safe driving by the driver and prevent a traffic accident.

The current camera for a vehicle has a significantly low level of image quality, as compared to a digital camera, due to problems of a camera module such as restrictions in optical zoom, autofocus, and resolution as well as problems of a circuit such as limitations in power consumption amount, memory, and logic, etc. Particularly, in the case of the night vision system, even though a wide dynamic range (WDR) sensor is used, a large amount of low-luminance noise is generated and brightness of an image is significantly low, such that an object may not be easily recognized. Therefore, an algorithm for removing noise from a night image of the night vision camera and improving the image quality is necessary.

According to a related art, various methods for removing noise in a digital image processing device have been suggested; however, they do not appropriately take into consideration of a brightness value or a direction of an edge and a pattern of the noise of the image, such that the image is blurred or the edge is defected.

As the simplest method of reducing a noise component included in an image signal, there is a method of removing the noise by applying a low pass filter (LPF) to a target pixel and surrounding pixels. However, when the low pass filter is applied to all image pixels, edge information required for recognizing the object is also reduced together with the noise component of the image to reduce sharpness of the image, thereby deteriorating the image quality.

FIG. 1 is a view showing an image output from a night vision system according to the related art. Referring to FIG. 1, in the case of the image output from the night vision system, a bright region 10 around a road illuminated by a headlight of a vehicle and a significant dark region 20 on an upper end of the image are simultaneously generated. Therefore, noises generated in each region have distributions and strengths different from each other, thereby making it impossible to effectively remove noise using the method for removing noise according to the related art and maintain the sharpness of the image.

Meanwhile, the image output from the night vision system includes a larger amount of noise than that of a general image and has a significant low brightness value of the image. Therefore, a need exists for an image processing process for improving image quality.

In the case of the image processing process used in the night vision system according to the related art, a process for improving the brightness value of the image such as a gamma curve process, a histogram stretching process, a histogram equalizing process, or the like, is performed by a brightness improving unit before the noise components are removed. Here, the strength of the noise component included in the dark region of the image may be increased. Therefore, a low pass filter having higher strength is used, such that the amount of a memory and the complexity of a circuit are increased and the sharpness of the image is deteriorated.

### SUMMARY OF THE INVENTION

The present invention is to provide a method for removing noise, in which noise is removed by changing coefficient values of a low pass filter according to characteristics of an image, and a night-vision system capable of effectively removing noise by including noise removing units using the same, the noise removing units disposed before and behind a brightness improving unit.

According to an exemplary embodiment of the present invention, there is provided a method for removing noise, the method including: (a) photographing a night image around a vehicle and then, outputting a signal required for image processing; (b) segmenting the image according to a brightness value of the image and/or distribution of pixel data from the output signal; and (c) conducting filtering by applying different coefficient values of a low pass filter to each segmented image according to the brightness value of the image and/or the distribution of the pixel data.

Step (b) may include segmenting the image into a dark region, an intermediate region, and a bright region according to the brightness value of the image.

Step (b) may include segmenting the image into a point noise region in which the pixel data are distributed point by point, a texture region in which pixel data exist in plural without directionality to exist as texture components, an edge region in which the pixel data exist as edge components, and a homogeneous region in which the noise components, the texture components, and the edge components do not exist according to the distribution of the pixel data.

The method may further include determining a direction of the edge components and detecting whether the edge components continuously exist in the determined direction, with respect to the edge region.

According to a first exemplary embodiment of the present invention, there is provided a method for removing noise, the method including: (a) determining a target region to be processed using a mask filter with respect to an image of a front side of a vehicle and calculating a brightness value of a target pixel within the mask filter; (b) comparing the brightness value of the target pixel with a first threshold value to detect a dark region within the image; (c) comparing the brightness value of the target pixel with a second threshold value to detect an intermediate region or a bright region within the image when the dark region is not detected at step (b); (d) detecting an edge region within a region of the image detected as the bright region when the bright region is detected; and (e) conducting filtering by applying coefficient values of a low pass filter having a weight to pixels in which edge components exist with respect to a region of the image detected as the edge region.

The method may further include conducting filtering by applying the coefficient values of the low pass filter having a weight to the target pixel with respect to a region of the image detected as the dark region at step (b).

The method may further include conducting filtering by applying the coefficient values of the low pass filter having a weight lower than that of the dark region with respect to a region of the image detected as the intermediate region at step (c).

The method may further include conducting filtering by applying the coefficient values of the low pass filter uniformly assigned to the target pixel and surrounding pixels with respect to a region of the image in which the edge region is not detected at step (d).

The detecting of the edge region may include: calculating absolute differential values between the target pixel and surrounding pixels within the mask filter using Laplacian kernel and then, calculating the sum Adv of the absolute differential values in a vertical direction, the sum Adh of the absolute differential values in a horizontal direction, the sum Adr of the absolute differential values in a diagonal direction from the upper right to the lower left, and the sum Adl of the absolute differential values in a diagonal direction from the upper left to the lower right, as given by the following Equation:

Adv=|P11−P01|+|P11−P21|

Adh=|P11−P10|+|P11−P12|

Adr=|P11−P02|+|P11−P20|

Adl=|P11−P00|+|P11−P22|;

selecting a maximum value MAX(EDGE) and a minimum value MIN(EDGE) among the sums Adv, Adh, Adr, and Adl of the absolute differential values as, given by following Equation

MAX(EDGE)=MAX[Adv,Adh,Adr,Adl]

MIN(EDGE)=MIN[Adv,Adh,Adr,Adl]

DE=|MAX(EDGE)−MIN(EDGE)|;

comparing an absolute value DE of a value obtained by subtracting the minimum value MIN(EDGE) from the maximum value MAX(EDGE) with a predetermined threshold value; and determining that this region of the image is the edge region when the absolute value DE is larger than the predetermined threshold value.

According to a second exemplary embodiment of the present invention, there is provided a method for removing noise, the method including: (a) determining a target region to be processed using a mask filter with respect to an image of a front side of a vehicle and calculating a brightness value of a target pixel within the mask filter; (b) calculating absolute differential values between the target pixel and surrounding pixels within the mask filter and then, calculating the sum Adv of the absolute differential values in a vertical direction, the sum Adh of the absolute differential values in a horizontal direction, the sum Adr of the absolute differential values in a diagonal direction from the upper right to the lower left, and the sum Adl of the absolute differential values in a diagonal direction from the upper left to the lower right, as given by the following Equation:

Adv=|P11−P01|+|P11−P21|

Adh=|P11−P10|+|P11−P12|

Adr=|P11−P02|+|P11−P20|

Adl=|P11−P00|+|P11−P22|

with respect to all of the brightness value regions calculated at step (a); (c) detecting a homogeneous region within the image using the sums Adv, Adh, Adr, and Adl of the absolute differential values; (d) comparing the brightness value of the target pixel with a first predetermined threshold value to detect a dark region within a region of the image detected as the homogeneous region when the homogeneous region is detected at step (c); (e) comparing the brightness value of the target pixel with a second threshold value to detect an intermediate region or a bright region within a region of the image detected as the homogeneous region when the dark region is not detected at step (d); and (f) conducting filtering by applying coefficient values of a low pass filter having a weight to the target pixel with respect to a region of the image detected as the bright region.

The method may further include conducting filtering by applying the coefficient values of the low pass filter having a weight higher than that of the bright region with respect to a region of the image detected as the intermediate region at step (e).

The method may further include conducting filtering by applying the coefficient values of the low pass filter having a weight higher than that of the intermediate region with respect to a region of the image detected as the dark region at step (d).

The detecting of the homogeneous region may include: comparing the sums Adv, Adh, Adr, and Adl of the absolute differential values with a predetermined threshold value; and determining that this region of the image is the homogeneous region when all of the sums Adv, Adh, Adr, and Adl of the absolute differential values are smaller than the predetermined threshold value.

According to a third exemplary embodiment of the present invention, there is provided a method for removing noise, the method including: (a) determining a target region to be processed using a mask filter with respect to an image of a front side of a vehicle and calculating a brightness value of a target pixel within the mask filter; (b) calculating absolute differential values between the target pixel and surrounding pixels within the mask filter and then, calculating the sum Adv of the absolute differential values in a vertical direction, the sum Adh of the absolute differential values in a horizontal direction, the sum Adr of the absolute differential values in a diagonal direction from the upper right to the lower left, and the sum Adl of the absolute differential values in a diagonal direction from the upper left to the lower right, as given by the following Equation:

Adv=|P11−P01|+|P11−P21|

Adh=|P11−P10|+|P11−P12|

Adr=|P11−P02|+|P11−P20|

Adl=|P11−P00|+|P11−P22|

with respect to all of the brightness value regions calculated at step (a); (c) detecting a homogeneous region within the image using the sums Adv, Adh, Adr, and Adl of the absolute differential values; (d) detecting an edge region within the image using the sums Adv, Adh, Adr, and Adl of the absolute differential values when the homogeneous region is not detected at step (c); (e) detecting a point noise region or a texture region within the image using the sums Adv, Adh, Adr, and Adl of the absolute differential values when the edge region is not detected at step (d); (f) comparing the brightness value of the target pixel with a second predetermined threshold value to detect an intermediate region or a bright region within a region of the image detected as the texture region when the texture region is detected; and (g) conducting filtering by applying coefficient values of a low pass filter uniformly assigned to the target pixel and surrounding pixels with respect to a region of the image detected as the bright region.

The method may further include filtering by applying the coefficient values of the low pass filter uniformly assigned to the target pixel and surrounding pixels and applying coefficient values of a low pass filter having a weight to the target pixel with respect to a region of the image detected as the intermediate region at step (f).

The method may further include filtering by applying the coefficient values of the low pass filter having a weight to the target pixel with respect to a region of the image detected as the point noise region at step (e).

The detecting of the point noise region may include: comparing the sums Adv, Adh, Adr, and Adl of the absolute differential values with a predetermined threshold value; and determining that this region of the image is the point noise region when all of the sums Adv, Adh, Adr, and Adl of the absolute differential values are larger than the predetermined threshold value.

The detecting of the textual region may include: comparing the sums Adv, Adh, Adr, and Adl of the absolute differential values with a predetermined threshold value; and determining that this region of the image is the texture region when even any one of the sums Adv, Adh, Adr, and Adl of the absolute differential values is smaller than the predetermined threshold value.

According to a fourth exemplary embodiment of the present invention, there is provided a method for removing noise, the method including: (a) determining a target region to be processed using a mask filter with respect to an image of a front side of a vehicle and calculating a brightness value of a target pixel within the mask filter; (b) calculating absolute differential values between the target pixel and surrounding pixels within the mask filter and then, calculating the sum Adv of the absolute differential values in a vertical direction, the sum Adh of the absolute differential values in a horizontal direction, the sum Adr of the absolute differential values in a diagonal direction from the upper right to the lower left, and the sum Adl of the absolute differential values in a diagonal direction from the upper left to the lower right, as given by the following Equation:

Adv=|P11−P01|+|P11−P21|

Adh=|P11−P10|+|P11−P12|

Adr=|P11−P02|+|P11−P20|

Adl=|P11−P00|+|P11−P22|

with respect to all of the brightness value regions calculated at step (a); (c) detecting a homogeneous region within the image using the sums Adv, Adh, Adr, and Adl of the absolute differential values; (d) detecting an edge region within the image using the sums Adv, Adh, Adr, and Adl of the absolute differential values when the homogeneous region is not detected at step (c); (e) determining a direction of edge components using the sums Adv, Adh, Adr, and Adl of the absolute differential values when the edge region is detected at step (d); (f) detecting whether the edge components continuously exist in the determined direction when the direction of the edge components is determined; (g) comparing the brightness value of the target pixel with a second predetermined threshold value to detect an intermediate region or a bright region within the image in which the edge region is detected when it is detected that the edge components continuously exist at step (f); and (h) conducting filtering by applying coefficient values of a low pass filer having a weight to pixels positioned in the direction in which the edge components exist with respect to a region of the image detected as the bright region.

The method may further include conducting filtering by applying the coefficient values of the low pass filter having a weight to the pixels positioned in the direction in which the edge components exist and the target pixel with respect to a region of the image detected as the intermediate region at step (g).

The method may further include conducting filtering by applying the coefficient values of the low pass filter having a weight to the pixels in which the edge components exist with respect to a region of the image detected that the edge components do not continuously exist at step (f).

The determining of the direction of the edge components may include: calculating an absolute value Dvh of a value obtained by subtracting Adh from Adv and an absolute value Drl of a value obtained by subtracting Adl from Adr; comparing Dvh with Dvl and comparing Adv with Adh or Adr with Adl according to the comparison result; comparing Adv with Adh when Dvh is larger than Dvl to determine that the edge components exist in the horizontal direction when Adv is larger than Adh and determine that the edge components exist in the vertical direction when Adv is smaller than Adh; and comparing Adr with Adl when Drl value is larger than Dvh to determine that the edge components exist in the diagonal direction from the upper right to the lower left when Adr is larger than Adl and determine that the edge components exist in the diagonal direction from the upper left to the lower right when Adr is smaller than Adl, as given by the following Equation:

Dvh=|Adv−Adh|,Drl=|Adr−Adl|

if(Dvh>Drl)&&(Adv>Adh)≅Horizontal Edge

sdv_{—}1=|P10−P00|+|P10−P20|

sdv_{—}2=|P12−P02|+|P12−P22|

if(Dvh>Drl)&&(Adh>Adv)≅Vertical Edge

sdh_{—}1=|P01−P00|+|P01−P02|

sdh_{—}2=|P21−P20|+|P21−P22|

if(Drl>Dvh)&&(Adr>Adl)≅Left Diagonal Edge

sdr_{—}1=|P00−P01|+|P00−P10|

sdr_{—}2=|P22−P12|+|P22−P21|

if(Drl>Dvh)&&(Adl>Adr)≅Right Diagonal Edge

sdl_{—}1=|P02−P01|+|P02−P12|

sdl_{—}2=|P20−P10|+|P20−P21|

The detecting of whether the edge components continuously exist in the determined direction may include: calculating the absolute differential values between two surrounding pixels in the vicinity of a center pixel positioned in the direction determined that the edge components exist at step (e) and surrounding pixels adjacent to the two surrounding pixels and summing the calculated absolute differential values to calculate sdv_1 and sdv_2, sdh_1 and sdh_2, sdr_1 and sdr_2, or sdl_1 and sdl_2; comparing sdv_1 and sdv_2, sdh_1 and sdh_2, sdr_1 and sdr_2, or sdl_1 and sdl_2 with the predetermined threshold value; and determining that the edge components continuously exist in the determined direction when all of sdv_1 and sdv_2, sdh_1 and sdh_2, sdr_1 and sdr_2, or sdl_1 and sdl_2 are larger than the threshold value, as given by the following Equation:

Dvh=|Adv−Adh|,Drl=|Adr−Adl|

if(Dvh>Drl)&&(Adv>Adh)≅Horizontal Edge

sdv_{—}1=|P10−P00|+|P10−P20|

sdv_{—}2=|P12−P02|+|P12−P22|

if(Dvh>Drl)&&(Adh>Adv)≅Vertical Edge

sdh_{—}1=|P01−P00|+|P01−P02|

sdh_{—}2=|P21−P20|+|P21−P22|

if(Drl>Dvh)&&(Adr>Adl)≅Left Diagonal Edge

sdr_{—}1=|P00−P01|+|P00−P10|

sdr_{—}2=|P22−P12|+|P22−P21|

if(Drl>Dvh)&&(Adl>Adr)≅Right Diagonal Edge

sdl_{—}1=|P02−P01|+|P02−P12|

sdl_{—}2=|P20−P10|+|P20−P21|

According to another exemplary embodiment of the present invention, there is provided a night vision system displaying a night image around a vehicle sensed from a camera module on a display, the night vision system including: a first noise removing unit removing noise by filtering compositions serving as the noise in an image signal output from an image sensor; a brightness improving unit improving a brightness value of the image in which the noise components are removed by the first noise removing unit; a second noise removing unit removing the noise by filtering components serving as the noise in the image in which the brightness value is improved by the brightness improving unit; and a signal processing unit processing the image signal in which the brightness value is improved and the noise components are removed and outputting the image signal to the display.

The first noise removing unit may perform the method according to a first exemplary embodiment.

The second noise removing unit may perform the method according to second to fourth exemplary embodiments.

The first noise removing unit may perform the method according to a first exemplary embodiment, and the second noise removing unit may perform the method according to second to fourth exemplary embodiments.

### BRIEF DESCRIPTION OF THE DRAWINGS

FIG. 1 is a view showing an image output from a night vision system according to the related art;

FIG. 2 is a flowchart showing an operation flow of a method for removing noise according to an exemplary embodiment of the present invention;

FIG. 3 is a view showing a 3×3 mask filter used in a method for removing noise according to an exemplary embodiment of the present invention;

FIG. 4 is a flowchart showing an operation flow of a method for removing noise according to a first exemplary embodiment of the present invention;

FIG. 5A is a flowchart showing an operation flow of a method for removing noise according to a second exemplary embodiment of the present invention;

FIG. 5B is a flowchart showing an operation flow of a method for removing noise according to a third exemplary embodiment of the present invention;

FIG. 5C is a flowchart showing an operation flow of a method for removing noise according to a fourth exemplary embodiment of the present invention;

FIG. 6 is a block diagram of a night vision system according to an exemplary embodiment of the present invention;

FIG. 7A is a view showing an image in which a brightness value is improved without removing noise;

FIG. 7B is a partially enlarged view of part A of FIG. 7A;

FIG. 8A is a view showing an image in which a brightness value is improved after noise components are removed by a first noise removing unit of a night vision system according to an exemplary embodiment of the present invention;

FIG. 8B is a partially enlarged view of part B of FIG. 8A;

FIG. 9A is a view showing an image finally output from a night vision system according to the related art; and

FIG. 9B is a view showing an image finally output from a night vision system according to an exemplary embodiment of the present invention.

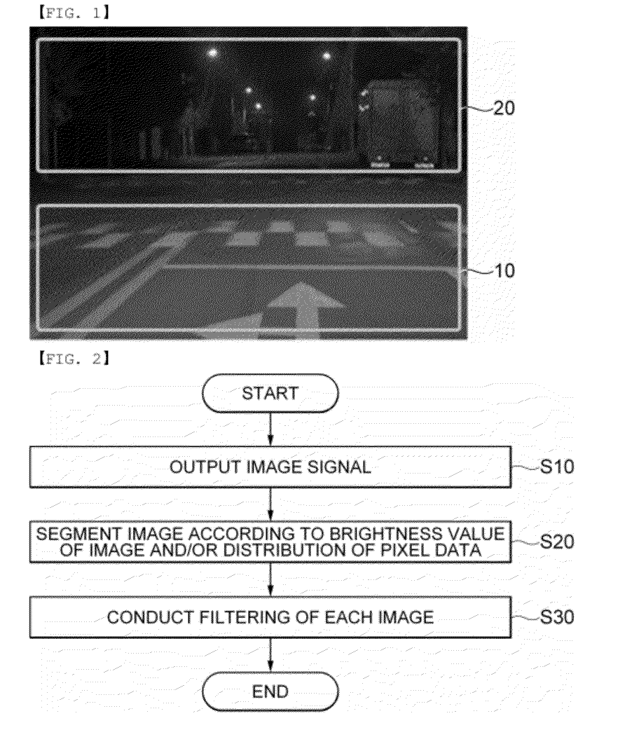

### DESCRIPTION OF THE PREFERRED EMBODIMENTS

Hereinafter, exemplary embodiments of the present invention will be described in detail with reference to the accompanying drawings. The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

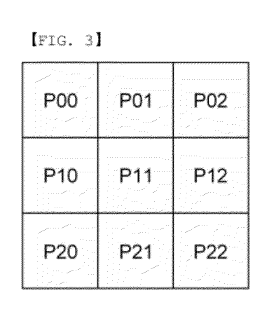

FIG. 2 is a flowchart showing an operation flow of a method for removing noise according to an exemplary embodiment of the present invention.

Referring to FIG. 2, in a method for removing noise according to an exemplary embodiment of the present invention, an operation of photographing a night image of a front side of a vehicle and then, outputting a signal required for processing the image is first performed (S10).

The operation S10 may be performed by a camera module (not shown) mounted on the front side of the vehicle. The camera module may be configured of a lens receiving the night image of the front side of the vehicle from infrared rays reflected by an object and an image sensor converting the received night image into the signal required for processing the image to output the converted signal.

Then, an operation of segmenting the image according to a brightness value of the image and/or distribution of pixel data using the signal output from the image sensor is performed (S20).

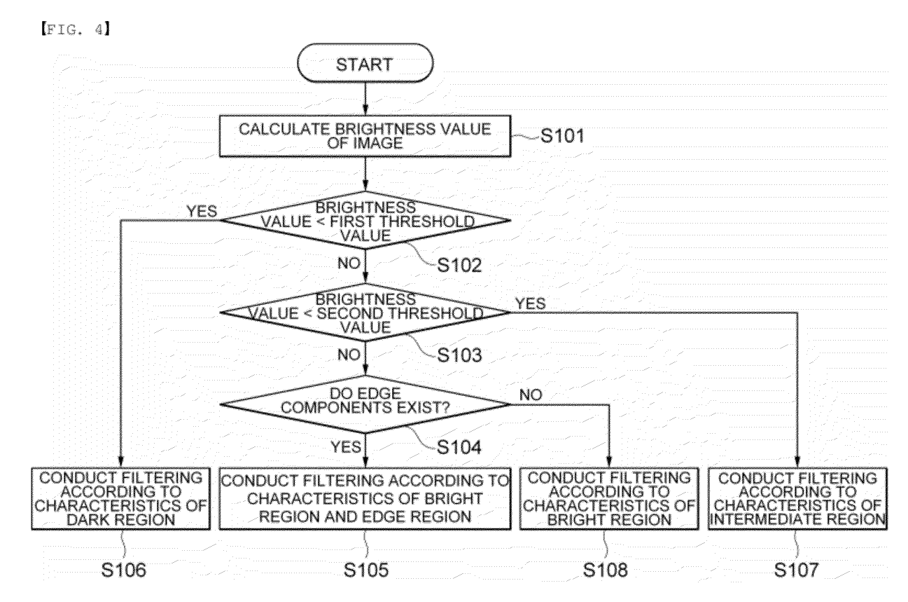

FIG. 3 is a view showing a 3×3 mask filter used in a method for removing noise according to an exemplary embodiment of the present invention.

A mask filter defines a predetermined pixel region of the image. In order to segment the image according to characteristics of the image, a region including a target pixel P11, which is a processing target of a low pass filter, and at least one surrounding pixels P00, P01, P02, P10, P12, P20, P21, and P22 adjacent to the target pixel P11 should be first determined using the 3×3 mask filter, as shown in FIG. 3. Here, nine filter regions divided within the 3×3 mask filter the unit pixels while scanning the unit pixels, corresponding to the unit pixels of the image. In some cases, in addition to the 3×3 mask filter, a 5×5 mask filter, etc., is used, such that a plurality of unit pixels may be configured correspondingly.

After the target pixel and the surrounding pixels are determined by the 3×3 mask filter, an operation of calculating a brightness value of the target pixel P11, which is the processing target of the low pass filter, is performed in order to segment the image according to the brightness value of the image.

A process of calculating the brightness value of the image is given by Equation 1 below.

AVG(BR)=(SUM[P00:P22]−P11)/8 [Equation 1]

As given by Equation 1, the brightness value of the target pixel P11, which is the processing target of the low pass filter, may be calculated by calculating an average value AVG(BR) of the surrounding pixels P00, P01, P02, P10, P12, P20, P21, and P22.

After the brightness value of the target pixel P11 is calculated, the brightness value of the target pixel P11 may be compared with a predetermined threshold value, thereby making it possible to segment the image according to the brightness value. Here, the threshold value, which is a value experimentally set to have the most excellent performance, is preferably set to first and second threshold values in order to segment the image into a dark region, an intermediate region, and a bright region. That is, when the brightness value is smaller than the first threshold value, the image may be segmented into the dark region, when the brightness value is larger than the first threshold value and is smaller than the second threshold value, the image may be segmented into the intermediate region, and when the brightness value is larger than the second threshold value, the image may be segmented into the bright region.

In addition, an operation of segmenting the image into a point noise region in which the pixel data are distributed point by point, a texture region in which pixel data exist in plural without directionality to exist as texture components, an edge region in which the pixel data exist as edge components, and a homogeneous region in which the noise components, the texture components, and the edge components do not exist, according to the distribution of the pixel data, is performed.

Particularly, with respect to the image segmented into the edge region, an operation of determining a direction of the edge components and detecting whether the edge components continuously exist in the determined direction may be additionally performed.

The operation of segmenting the image into the homogeneous region, the point noise region, the texture region, and the edge region and the operation of determining the direction of the edge components and detecting whether the edge components continuously exist in the determined direction will be described in methods for removing noise according to exemplary embodiments of the present invention below.

After the image is segmented according to the brightness value of the image and/or the distribution of the pixel data, an operation of conducting filtering by applying different coefficient values of the low pass filter to each segmented image according to the brightness value of the image and/or the distribution of the pixel data is performed (S30).

The coefficient values of the low pass filter applied to each image will be described in detail in methods for removing noise according to exemplary embodiments of the present invention below.

As described above, the night image used in the night vision system has a bright pixel value with respect to the road illuminated by the headlight of the vehicle and objects around the road; however, the night image has a significantly low pixel value with respect to an upper portion thereof. These dark regions include a large amount of noise due to shortage of light amount. Therefore, the coefficient values of the low pass filter are adjusted so that filtering having high strength may be performed with respect to the image of the dark region. On the contrary, the coefficient values of the low pass filter are adjusted so that filtering having lower strength may be performed as the brightness value of the image becomes higher. As a result, it is possible to effectively remove the noise components, while maintaining sharpness of the image quality.

Meanwhile, similar to the image of the dark region, with respect to the homogeneous region in which there is no need to maintain the sharpness and the image of the point noise region that includes the noise components, the coefficient values of the low pass filter are adjusted so that the filtering having high strength may be performed. Similar to the bright region, with respect to the texture region in which the pixel data exist in plural without directionality to exist as the texture components such as an object, an obstacle, or the like, that should be recognized by the driver, the coefficient values of the low pass filter are adjusted so that the filtering having low strength may be performed. As a result, it is possible to effectively remove the noise components, while maintaining the sharpness of the image quality.

With respect to the edge region, the coefficient values of the low pass filter are adjusted so that the filtering may be performed on the pixels except for the edge components, thereby making it possible to effectively remove the noise components, while maintaining the edge components.

Particularly, with respect to a region of the image detected that the edge components continuously exist in the predetermined direction in the edge region, the coefficient values of the low pass filter are adjusted so that the edge components continuously existing in a predetermined direction are excluded, thereby making it possible to effectively remove the noise component without causing a phenomenon that the image is blurred in the direction in which the edge components exist.

Hereinafter, a method for removing noise according to a first exemplary embodiment of the present invention will be described.

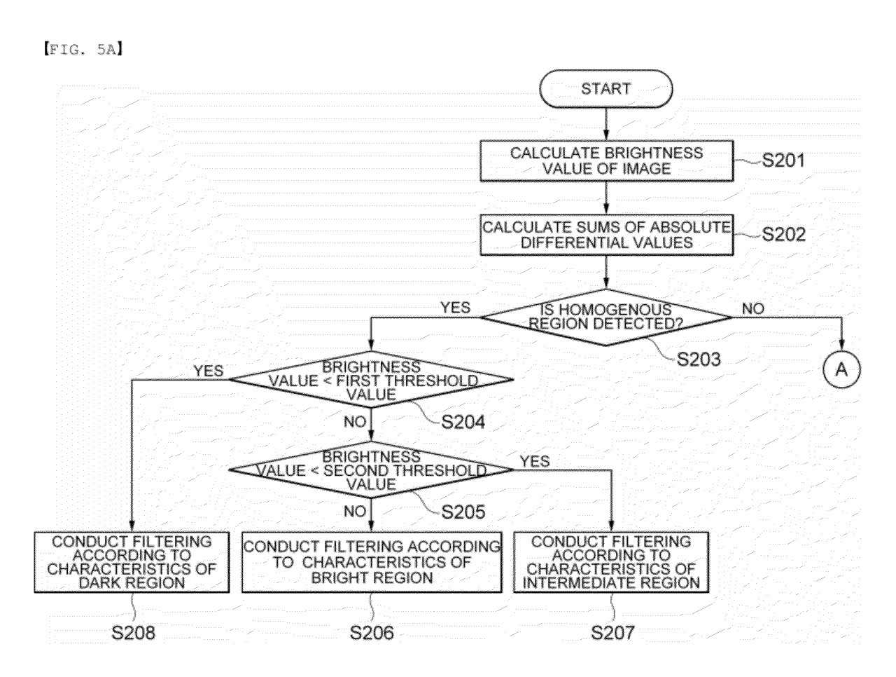

FIG. 4 is a flowchart showing an operation flow of a method for removing noise according to a first exemplary embodiment of the present invention. An operation of determining a target region to be processed using the mask filter with respect to the image of the front side of the vehicle and calculating the brightness value of the target pixel within the mask filter is first performed (S101). The brightness value of the target pixel may be calculated by Equation 1.

After the brightness value of the target pixel is calculated, an operation of comparing the brightness value of the target pixel with a first predetermined threshold value to detect the dark region within the image is performed (S102). When the brightness value of the target pixel is smaller than the first threshold value, it may be determined that this region of the image is the dark region.

When the dark region is not detected in the comparison between the brightness value of the target pixel and the first threshold value at the operation S102, an operation of comparing the brightness value of the target pixel with a second threshold value to detect the intermediate region or the bright region within the image is performed (S103). When the brightness value of the target pixel is smaller than the second threshold value, it may be determined that this region of the image is the intermediate region, and when the brightness value of the target pixel is larger than the second threshold value, it may be determined that this region of the image is the bright region.

Then, an operation of detecting whether the edge components exist within a region of the image detected as the bright region is performed (S104).

A process of detecting whether the edge components exist is given by Equation 2 and Equation 3 below.

Adv=|P11−P01|+|P11−P21|

Adh=|P11−P10|+|P11−P12|

Adr=|P11−P02|+|P11−P20|

Adl=|P11−P00|+|P11−P22| [Equation 2]

MAX(EDGE)=MAX[Adv,Adh,Adr,Adl]

MIN(EDGE)=MIN[Adv,Adh,Adr,Adl]

DE=|MAX(EDGE)−MIN(EDGE)| [Equation 3]

First, as given by Equation 2, differences (hereinafter, referred to as absolute differential values) in signal strength between the target pixel and the surrounding pixels are calculated using Laplacian kernel, and the sums of the absolute differential values calculated in each direction in which the surrounding pixels exist are then calculated. That is, in the case of the 3×3 mask filter, the number of surrounding pixels is eight, such that eight absolute differential values may be calculated in one mask filter. Therefore, the sum Adv of absolute differential values in a vertical direction, the sum Adh of absolute differential values in a horizontal direction, the sum Adr of absolute differential values in a diagonal direction from the upper right to the lower left, and the sum Adl of absolute differential values in a diagonal direction from the upper left to the lower right may be calculated in each direction in which the surrounding pixels exist.

Next, as given by Equation 3, a maximum value MAX(EDGE) and a minimum value MIN(EDGE) are selected among Adv, Adh, Adr, and Adl, a value DE obtained by subtracting the selected minimum value MIN(EDGE) from the selected maximum value MAX(EDGE) is compared with a predetermined threshold value, and it may be determined that the edge components exist when the DE is larger than the threshold value.

The absolute differential values calculated by Equation 2 mean the change amount between the pixels in each direction. Therefore, the maximum value MAX(EDGE) indicates that the change amount between the pixels is the largest in the direction determined as the maximum value and the minimum value MIN(EDGE) indicates that the change amount between the pixels is the smallest in the direction determined as the minimum value. Therefore, when the noise components exist within the mask filter, the change amount between the pixels is large in all directions, such that the DE is small. Likewise, when the edge components do not exist within the mask filter, the change amount between the pixels is small in all directions, such that the DE becomes small. However, when the edge components exist within the mask filter, the change amount between the pixels is small in the direction in which the edge components exist, such that the sum (for example, one of Adv, Adh, Adr, and Adl) of the absolute differential values in the direction in which the edge components exist is selected as the minimum value MIN(EDGE) and one of the sums of the absolute differential values in the directions other than the direction is selected as the maximum value MAX(EDGE). As a result, the DE becomes large. Therefore, when the DE is larger than the predetermined threshold value, it may be detected that the edge components exist.

Then, with respect to a region of the image detected that the edge components exist, an operation of conducting filtering by applying coefficient values of the low pass filter having a weight to the pixels in which the edge components exist so that the edge component may be conserved is performed (S105).

In addition, with respect to a region of the image detected as the dark region due to the brightness value of the target pixel smaller than the first threshold value at the operation S102, an operation of conducting filtering by applying coefficient values of the low pass filter having a weight to the target pixel so that the filtering having high strength may be conducted according to characteristics of the dark region having many noise components is performed (S106).

Further, with respect to a region of the image detected as the intermediate region due to the brightness value of the target pixel smaller than the second threshold value at the operation S103, an operation of conducting filtering by applying coefficient values of the low pass filter having a weight smaller than that of the dark region according to characteristics of the intermediate region having the noise components less than those of the dark region is performed (S107).

In addition, with respect to the region of the image detected that the edge components do not exist within the region of the image detected as the bright region due to the DE smaller than the predetermined threshold value at the operation S104, an operation of conducting filtering by applying coefficient values of the low pass filter uniformly assigned to the target pixel and the surrounding pixels so that the filtering having low strength may be conducted according to characteristics of the bright region having few noise components is performed (S108).

That is, the night image input from the camera module is segmented into the bright region, the intermediate region, and the dark region according to the brightness value of the image, and the coefficient values of the low pass filter having high weight are applied to the target pixel so that the filtering having higher strength may be conducted as the brightness value becomes lower. With respect to the bright region in which the edge components may be detected, whether the edge components exist is determined and the filtering is then conducted. As a result, it is possible to effectively remove the noise components.

Hereinafter, a method for removing noise according to a second exemplary embodiment of the present invention will be described.

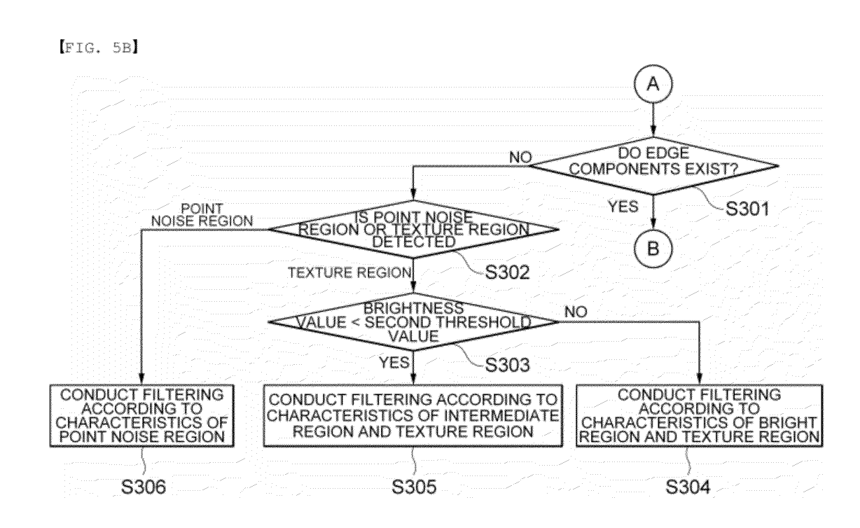

FIG. 5A is a flowchart showing an operation flow of a method for removing noise according to a second exemplary embodiment of the present invention. An operation of determining the target region to be processed using the mask filter with respect to the image of the front side of the vehicle and calculating the brightness value of the target pixel within the mask filter is first performed (S201). The brightness value of the target pixel may be calculated by Equation 1.

After the brightness value of the target pixel is calculated, with respect to all of the calculated brightness value regions, an operation of calculating the absolute differential values between the target pixel and the surrounding pixels using Laplacian kernel and then, calculating the sum Adv of the absolute differential values in the vertical direction, the sum Adh of the absolute differential values in the horizontal direction, the sum Adr of the absolute differential values in the diagonal direction from the upper right to the lower left, and the sum Adl of the absolute differential values in the diagonal direction from the upper left to the lower right in each direction in which the surrounding pixels exist, as given by Equation 2 is performed (S202).

While the sums of the absolute differential values in each direction based on the target pixel P11 are calculated only with respect to the bright region in order to detect that the edge components exists in the first exemplary embodiment of the present invention, the sums Adv, Adh, Adr, and Adl of the absolute differential values are calculated with respect to all of the brightness value regions in order to more finely remove noise in the second exemplary embodiment of the present invention.

Then, an operation of detecting the homogeneous region within the image using the sums Adv, Adh, Adr, and Adl of the absolute differential values calculated in the operation S202 is performed (S203).

The operation of detecting the homogeneous region may include an operation of comparing the sums Adv, Adh, Adr, and Adl of the absolute differential values with the predetermined threshold value and an operation of determining that this region of the image is the homogeneous region when all of the sums Adv, Adh, Adr, and Adl of the calculated absolute differential values are smaller than the predetermined threshold value.

Since the sums Adv, Adh, Adr, and Adl of the absolute differential values calculated by Equation 2 means the change amount between the pixels in each direction, in the case of the homogeneous region in which the edge components, the noise components, or the texture components do not exist, the change amounts between the pixels are small in all directions. Therefore, when all of the sums Adv, Adh, Adr, and Adl of the absolute differential values are smaller than the predetermined threshold value, the homogeneous region may be detected.

When the homogeneous region is detected at the operation S203, an operation of comparing the brightness value of the target pixel with the first predetermined threshold value to detect the dark region within a region of the image detected as the homogenous region is performed (S204). Here, when the brightness value of the target pixel is smaller than the first threshold value, it may be determined that this region of the image is the dark region.

When the brightness value of the target pixel is larger than the first threshold value, an operation of comparing the brightness value of the target pixel with the second threshold value to detect the intermediate region and the bright region within the region of the image detected as the homogeneous region is performed (S205). When the brightness value of the target pixel is smaller than the second threshold value, it may be determined that this region of the image is the intermediate region, and when the brightness value of the target pixel is larger than the second threshold value, it may be determined that this region of the image is the bright region.

Then, with respect to the region of the image detected as the bright region, an operation of conducting filtering by applying the coefficient values of the low pass filter having the weight to the target pixel so that the filtering having high strength may be conducted according to characteristics of the homogeneous region in which there is no need to maintain the sharpness is performed (S206).

Further, with respect to the region of the image detected as the intermediate region due to the brightness value of the target pixel smaller than the second threshold value at the operation S205, an operation of conducting filtering by applying the coefficient values of the low pass filter having a weight higher than that of the bright region according to the characteristics of homogeneous region in which there is no need to maintain the sharpness and the characteristics of the intermediate region having the noise components more than those of the bright region is performed (S207).

Further, with respect to the region of the image detected as the dark region due to the brightness value of the target pixel smaller than the first threshold value at the operation S204, an operation of conducting filtering by applying the coefficient values of the low pass filter having a weight higher than that of the intermediate region so that the filtering having high strength may be conducted according to the characteristics of homogeneous region in which there is no need to maintain the sharpness and the characteristics of the dark region having the noise components more than those of the intermediate region is performed (S208).

That is, with respect to the region of the image detected as the homogeneous region, the coefficient values of the low pass filter having the weight are applied to the target pixel so that the filtering having the generally high strength may be conducted, taking into consideration that there is no need to maintain the sharpness. Further, the coefficient values of the low pass filter having gradually higher weight are applied to the target pixel so that the filtering having higher strength may be conducted in order from the bright region to the dark region according to the brightness value of the image. As a result, it is possible to effectively remove the noise components.

Hereinafter, a method for removing noise according to a third exemplary embodiment of the present invention will be described.

FIG. 5B is a flowchart showing an operation flow of a method for removing noise according to a third exemplary embodiment of the present invention. First, the operations S201, S202, and S203 are sequentially performed. The operations S201, S202, and S203 are the same as those in the second exemplary embodiment of the present invention. Therefore, a detailed description thereof will be omitted.

When the homogeneous region is not detected at the operation S203, an operation of detecting the edge region within the image using the sums Adv, Adh, Adr, and Adl of the absolute differential values is performed (S301). The edge region may be detected by Equation 3.

When the edge region is not detected at the operation S301, an operation of detecting the point noise region or the texture region within the image using the sums Adv, Adh, Adr, and Adl of the absolute differential values is performed (S302).

The operation of detecting the texture region may include an operation of comparing the sums Adv, Adh, Adr, and Adl of the absolute differential values with the predetermined threshold value and an operation of detecting that this region of the image is the texture region when even any one of the sums Adv, Adh, Adr, and Adl of the absolute differential values is smaller than the predetermined threshold value. The operation of detecting the point noise region may include an operation of comparing the sums Adv, Adh, Adr, and Adl of the absolute differential values with the predetermined threshold value and an operation of detecting that this region of the image is the point noise region when all of the sums Adv, Adh, Adr, and Adl of the absolute differential values are larger than the predetermined threshold value.

That is, as described above, when all of the sums Adv, Adh, Adr, and Adl of the absolute differential values are smaller than the predetermined threshold value, it may be detected that this region of the image is the homogeneous region. Likewise, when the noise components exist in the mask filter, the change amount between the pixels is large in all directions. Therefore, when all of the sums Adv, Adh, Adr, and Adl of the absolute differential values are larger than the predetermined threshold value, it may be determined that this region of the image is the point noise region, and when even any one of the sums Adv, Adh, Adr, and Adl of the absolute differential values is smaller than the predetermined threshold value, it may be determined that this region of the image is the texture region.

When the texture region is detected at the operation S302, an operation of comparing the brightness value of the target pixel with the second predetermined threshold value to detect the intermediate region or the bright region within a region of the image detected as the texture region is performed (S303). When the brightness value of the target pixel is smaller than the second threshold value, it may be determined that this region of the image is the intermediate region, and when the brightness value of the target pixel is larger than the second threshold value, it may be determined that this region of the image is the bright region.

Then, with respect to the region of the image detected as the bright region, an operation of conducting filtering by applying the coefficient values of the low pass filter uniformly assigned to the target pixel and the surrounding pixels is performed (S304), and with respect to the region of the image detected as the intermediate region, an operation of conducting filtering by applying the coefficient values of the low pass filter uniformly assigned to the target pixel and the surrounding pixels and applying the coefficient values of the low pass filter having the weight to the target pixel is performed (S305).

That is, in the case of the texture region, the filtering having generally low strength is conducted by applying the coefficient values of the low pass filter uniformly assigned to the target pixel and the surrounding pixels so that the texture components configuring the object or the obstacle that should by recognized by the driver may be conserved. Further, the coefficient values of the low pass filter having the weight is applied to the target pixel so that the filtering having gradually higher strength may be conducted in order from the bright region to the intermediate region in consideration of the brightness value of the image. As a result, it is possible to effectively remove the noise component.

Meanwhile, with respect to a region of the image detected as the point noise region at the operation S302, an operation of conducting filtering by applying the coefficient value of the low pass filter having the weight to the target pixel so that the filtering having strong strength may be conducted according to characteristics of the point noise region having many noise components is performed (S306).

In the case of the point noise region including only the noise components, unlike the region of the image detected as the homogeneous region, the coefficient values of the low pass filter having the weight are directly applied to the target pixel without being subject to the operation of segmenting the image according to the brightness value of the image, thereby making it possible to completely remove the noise components.

Hereinafter, a method for removing noise according to a fourth exemplary embodiment of the present invention will be described.

FIG. 5C is a flowchart showing an operation flow of a method for removing noise according to a fourth exemplary embodiment of the present invention. The operations S201, S202, S203, and S301 are sequentially performed. The operations S201, S202, S203, and S301 are the same as those in the second and third exemplary embodiments of the present invention. Therefore, a detailed description thereof will be omitted.

When the edge region is detected at the operation S301, an operation of determining the direction of the edge components using the sums Adv, Adh, Adr, and Adl of the absolute differential values is performed (S401).

A process of determining the direction of the edge components and detecting whether the edge components continuously exist in the determined direction is given by Equation 4.

Dvh=|Adv−Adh|,Drl=|Adr−Adl|

if(Dvh>Drl)&&(Adv>Adh)≅Horizontal Edge

sdv_{—}1=|P10−P00|+|P10−P20|

sdv_{—}2=|P12−P02|+|P12−P22|

if(Dvh>Drl)&&(Adh>Adv)≅Vertical Edge

sdh_{—}1=|P01−P00|+|P01−P02|

sdh_{—}2=|P21−P20|+|P21−P22|

if(Drl>Dvh)&&(Adr>Adl)≅Left Diagonal Edge

sdr_{—}1=|P00−P01|+|P00−P10|

sdr_{—}2=|P22−P12|+|P22−P21|

if(Drl>Dvh)&&(Adl>Adr)≅Right Diagonal Edge

sdl_{—}1=|P02−P01|+|P02−P12|

sdl_{—}2=|P20−P10|+|P20−P21| [Equation 4]

The operation of determining the direction of the edge components includes the following operations. As given by Equation 4, an operation of calculating an absolute value Dvh of a value obtained by subtracting Adh from Adv and an absolute value Drl of a value obtained by subtracting Adl from Adr is first performed.

Then, an operation of comparing Dvh with Dvl and comparing Adv with Adh or Adr with Adl according to the comparison result is performed.

When Dvh is larger than Dvl, an operation of comparing Adv with Adh to determine that the edge components exist in the horizontal direction when Adv is larger than Adh and determine that the edge components exist in the vertical direction when Adv is smaller than Adh is performed.

On the other hand, when Drl value is larger than Dvh, an operation of comparing Adr with Adl to determine that the edge components exist in the diagonal direction from the upper right to the lower left when Adr is larger than Adl and determine that the edge components exist in the diagonal direction from the upper left to the lower right when Adr is smaller than Adl is performed.

Since the sums Adv, Adh, Adr, and Adl of the absolute differential values means the change amount between the pixels in each direction, in the case in which the edge components exist in the horizontal direction, Adh is the smallest, and Adv, Adr, and Adl values other than Adh are relatively large. Therefore, Dvh is larger than Dvl, and Adv is larger than Adh. A similar description may be applied to the case in which the edge components exist in the vertical direction, the case in which the edge components exist in the diagonal direction from the upper right to the lower left, and the case in which the edge components exist in the diagonal direction from the upper left to the lower right.

After the direction in which the edge component exists is determined, an operation of detecting whether the edge components continuously exist in the determined direction is performed (S402).

The operation of detecting whether the edge components continuously exist includes following operations. First, an operation of calculating the absolute differential values between two surrounding pixels (for example, P10 and P12 in the case in which the edge components exist in the horizontal direction) in the vicinity of a center pixel P11 positioned in the direction determined that the edge components exist at the operation S401 and surrounding pixels (for example, P00 and P20 with respect to P10 and P02, and P22 with respect to P12) adjacent to the two surrounding pixels P10 and P12 and summing the calculated absolute differential values is performed (S402a).

When it is determined that the edge components exist in the horizontal direction, the sum sdv_1 of the absolute differential values for P10 and the sum sdv_2 of the absolute differential values for P12 may be calculated. When it is determined that the edge components exist in the vertical direction, the sum sdh_1 of the absolute differential values for P01 and the sum sdh_2 of the absolute differential values for P21, may be calculated. When it is determined that the edge components exist in the diagonal direction from the upper left to the lower right, the sum sdr_1 of the absolute differential values for P00 and the sum sdr_2 of the absolute differential values for P22 may be calculated. When it is determined that the edge components exist in the diagonal direction from the upper right to the lower left, the sum sdl_1 of the absolute differential values for P02 and the sum sdl_2 of the absolute differential values for P20 may be calculated.

When sdv_1 and sdv_2, sdh_1 and sdh_2, sdr_1 and sdr_2, or sdl_1 and sdl_2 are calculated at the operation S402a, an operation of comparing the calculated sdv_1 and sdv_2, sdh_1 and sdh_2, sdr_1 and sdr_2, or sdl_1 and sdl_2 with the predetermined threshold value is performed (S402b). When all of sdv_1 and sdv_2, sdh_1 and sdh_2, sdr_1 and sdr_2, or sdl_1 and sdl_2 are larger than the threshold value, an operation of determining that the edge components continuously exist in the determined direction is performed (S402c).

Since the sums of the absolute differential values mean the change amount between the pixels in each direction, when the edge components continuously exist in the horizontal direction, sdv_1 and sdv_2 has a large value. Therefore, when both of sdv_1 and sdv_2 are larger than the predetermined threshold value, it may be determined that the edge components continuously exist in the horizontal direction.

When it is detected that the edge components continuously exist, an operation of comparing the brightness value of the target pixel with the second predetermined threshold value to detect the intermediate region or the bright region within the image in which the edge region is detected is performed (S403). When the brightness value of the target pixel is smaller than the second threshold value, it may be determined that this region of the image is the intermediate region, and when the brightness value of the target pixel is larger than the second threshold value, it may be determined that this region of the image is the bright region.

With respect to the region of the image detected as the bright region, an operation of conducting filtering by applying the coefficient values of the low pass filter having the weight to the pixels positioned in the direction in which the edge components exist is performed (S404). With respect to the region of the image detected as the intermediate region, an operation of conducting filtering by applying the coefficient values of the low pass filter having the weight to the pixels positioned in the direction in which the edge components exist and the target pixel is performed (S405).

That is, the coefficient values of the lower pass filter having high weight are applied to the pixels positioned in the direction in which the edge components exist in consideration of the direction in which the edge components continuously exist. Further, the coefficient values of the lower pass filter having the weight is applied to the target pixel so that the filtering having gradually higher strength may be performed in order from the bright region to the intermediate region in consideration of the brightness value of the image. As a result, it is possible to effectively remove the noise components without causing the phenomenon that the image is blurred in the direction in which the edge components exist.

Meanwhile, with respect to the region of the image detected that the edge components do not continuously exist at the operation S402, an operation of conducting filtering by applying the coefficient values of the lower pass filter having the weight to the pixels in which the edge components exist is performed (S406).

Hereinafter, a night vision system using a method for removing noise according to an exemplary embodiment of the present invention will be described.

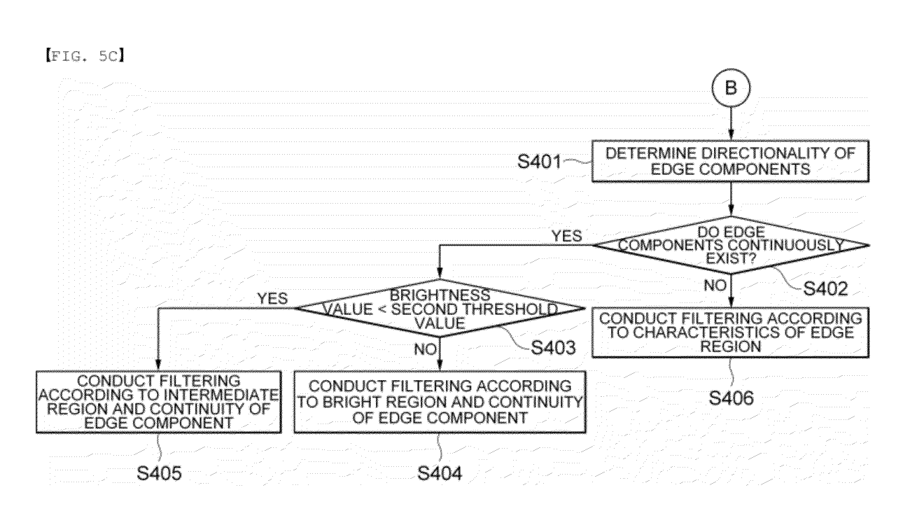

FIG. 6 is a block diagram of a night vision system according to an exemplary embodiment of the present invention.

Referring to FIG. 6, a night vision system 100 according to an exemplary embodiment of the present invention may be configured of a first noise removing unit 110 removing noise by filtering components serving as the noise in an image signal output from an image sensor, a brightness improving unit 120 improving a brightness value of the image in which the noise components are removed by the first noise removing unit 110; a second noise removing unit 130 removing the noise by filtering components serving as the noise in the image in which the brightness value is improved by the brightness improving unit 120; and a signal processing unit 140 processing the image signal in which the noise is removed and outputting the image signal to a display.

The first noise removing unit 110 is included before the bright improving unit 120 to remove the noise components included in the image signal output from the image sensor before the brightness value of the image is improved. The first noise removing unit 110 may perform the method of removing noise according to the first exemplary embodiment of the present invention.

In the case of the night image, sufficient information on the noise components cannot be obtained due to a low image signal level before the brightness value is improved by the brightness improving unit 120. Therefore, the image is first segmented into the bright region, the intermediate region, and the dark region according to the brightness value of the image, whether the edge components exist is detected with respect to the bright region in which the edge components may be detected, and the coefficient values of the low pass filter are applied according to the characteristics of each image, thereby making it possible to effectively remove the noise.

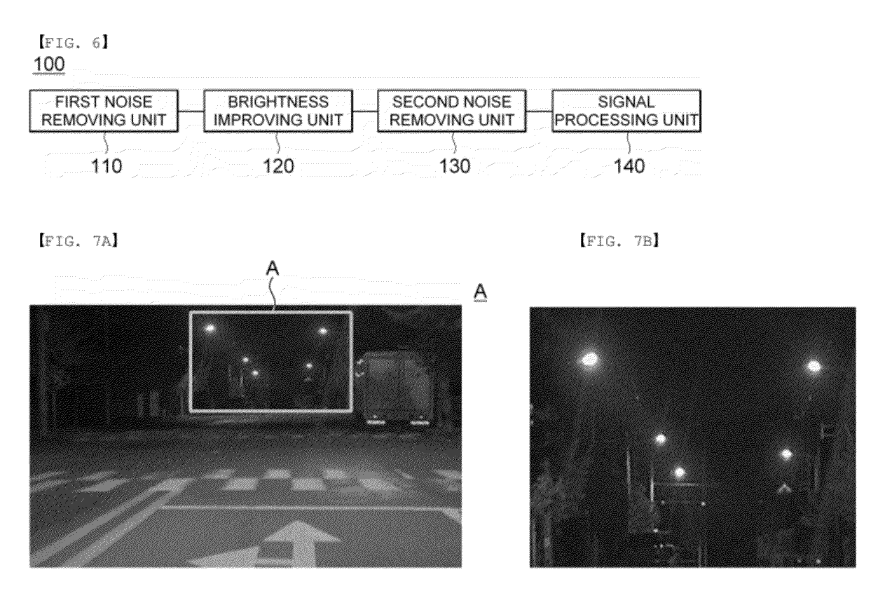

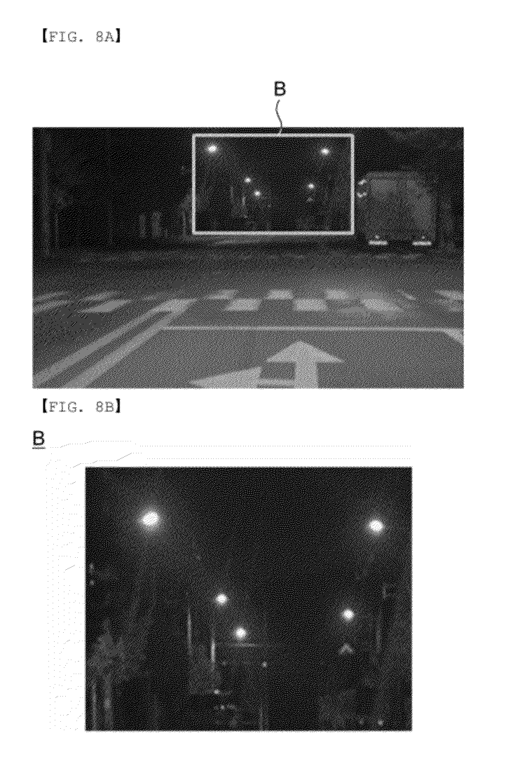

FIG. 7A is a view showing an image in which a brightness value is improved without removing noise; FIG. 7B is a partially enlarged view of part A of FIG. 7A; FIG. 8A is a view showing an image in which a brightness value is improved after noise components are removed by a first noise removing unit 110 of a night vision system according to an exemplary embodiment of the present invention; and FIG. 8B is a partially enlarged view of part B of FIG. 8A.

Comparing FIG. 7B with FIG. 8B, it may be appreciated that the first noise removing unit 110 is included in the night vision system according to an exemplary embodiment of the present invention, such that the noise components are removed before the brightness value of the night image is improved, thereby making it possible to prevent the noise components from being increased simultaneously with improvement of the brightness value and significantly remove the noise components in the dark region of the upper end of the image, while maintaining the sharpness in the bright region.

After the noise is removed by the first noise removing unit, the brightness improving unit 120 improves the brightness value of the image. As a method of improving the brightness value of the image, a gamma curve method, a histogram stretching method, a histogram equalizing method, or the like, may be used.

After the brightness value of the night image is improved by the brightness improving unit 120, the second noise removing unit 130 removes the noise components included in the image in which the brightness value is improved. Here, the second noise removing unit 130 may perform any one of the methods for removing noise according to the second to fourth exemplary embodiments of the present invention.

Since the first noise removing unit 110 removes the noise components before the brightness value of the image is improved, it is difficult to perfectly remove the noise components due to the low image signal level. Therefore, the noise components are finely removed by the second noise removing unit 130.

Taking into consideration that the image quality is improved to some degree by the first noise removing unit 110 and the brightness improving unit 120, unlike the first noise removing unit 110, the second noise removing unit 130 segments the image according to the distribution of the pixel data and then, segments each segmented image according to the brightness value of the image to conduct the filtering according to the characteristics of each image, thereby making it possible to finely remove the noise components.

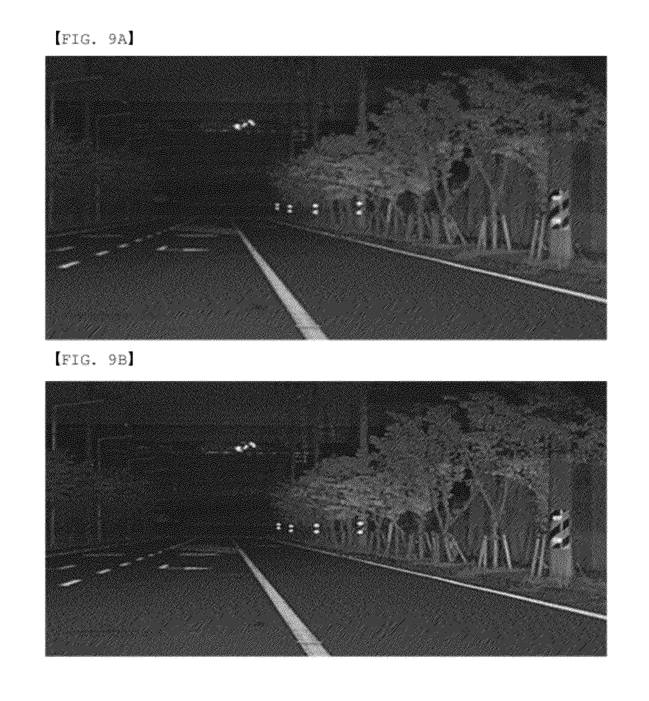

FIG. 9A is a view showing an image finally output from a night vision system according to the related art; and FIG. 9B is a view showing an image finally output from a night vision system according to an exemplary embodiment of the present invention.

Comparing FIG. 9A with FIG. 9B, it may be appreciated that the image finally output from the night vision system according to the exemplary embodiment of the present invention is improved in terms of a contour of the object and the sharpness, as compared to the image finally output from the night vision system according to the related art.

When the noise components included in the night image are removed by the first and second noise removing units 110 and 130 and the brightness value is improved by the brightness improving unit 120, the signal processing unit 140 serves to process the image signal in which the noise components are removed and the brightness value is improved, such that the image signal may be output to the display.

According to the exemplary embodiments of the present invention, the image is segmented according to the brightness value of the image and/or the distribution of the pixel data, and the low pass filter having different weights is applied to each segmented image, thereby making it possible to effectively remove noise while conserving the edge components and the texture components required for recognizing the object.

In addition, the night vision system including the first and second noise removing units using the method for removing noise according to the exemplary embodiments of the present invention disposed before/behind the brightness improving unit is provided, thereby making it possible to effectively remove the noise components, as compared to the circuit for removing noise used in the night vision system according to the related art.

Therefore, the configurations described and shown in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

What is claimed is:

1. A method for removing noise, the method comprising:
(a) photographing a night image around a vehicle and then, outputting a signal required for image processing:
(b) segmenting the image according to a brightness value of the image and/or distribution of pixel data from the output signal; and
(c) conducting filtering by applying different coefficient values of a low pass filter to each segmented image according to the brightness value of the image and/or the distribution of the pixel data.

2. The method according to claim 1, wherein step (b) includes segmenting the image into a dark region, an intermediate region, and a bright region according to the brightness value of the image.

3. The method according to claim 1, wherein step (b) includes segmenting the image into a point noise region in which the pixel data are distributed point by point, a texture region in which pixel data exist in plural without directionality to exist as texture components, an edge region in which the pixel data exist as edge components, and a homogeneous region in which the noise components, the texture components, and the edge components do not exist according to the distribution of the pixel data.

4. The method according to claim 3, further comprising determining a direction of the edge components and detecting whether the edge components continuously exist in the determined direction, with respect to the edge region.

5. A method for removing noise, the method comprising:
(a) determining a target region to be processed using a mask filter with respect to an image of a front side of a vehicle and calculating a brightness value of a target pixel within the mask filter;
(b) comparing the brightness value of the target pixel with a first threshold value to detect a dark region within the image;
(c) comparing the brightness value of the target pixel with a second threshold value to detect an intermediate region or a bright region within the image when the dark region is not detected at step (b);
(d) detecting an edge region within a region of the image detected as the bright region when the bright region is detected; and
(e) conducting filtering by applying coefficient values of a low pass filter having a weight to pixels in which edge components exist with respect to a region of the image detected as the edge region.

6. The method according to claim 5, further comprising conducting filtering by applying the coefficient values of the low pass filter having a weight to the target pixel with respect to a region of the image detected as the dark region at step (b).

7. The method according to claim 5, further comprising conducting filtering by applying the coefficient values of the low pass filter having a weight lower than that of the dark region with respect to a region of the image detected as the intermediate region at step (c).

8. The method according to claim 5, further comprising conducting filtering by applying the coefficient values of the low pass filter uniformly assigned to the target pixel and surrounding pixels with respect to a region of the image in which the edge region is not detected at step (d).

9. The method according to claim 5, wherein the detecting of the edge region includes:
calculating absolute differential values between the target pixel and surrounding pixels within the mask filter using Laplacian kernel and then, calculating the sum Adv of the absolute differential values in a vertical direction, the sum Adh of the absolute differential values in a horizontal direction, the sum Adr of the absolute differential values in a diagonal direction from the upper right to the lower left, and the sum Adl of the absolute differential values in a diagonal direction from the upper left to the lower right, as given by the following Equation:
Adv=|P11−P01|+|P11−P21|

Adh=|P11−P10|+|P11−P12|

Adr=|P11−P02|+|P11−P20|

Adl=|P11−P00|+|P11−P22|;
selecting a maximum value MAX(EDGE) and a minimum value MIN(EDGE) among the sums Adv, Adh, Adr, and Adl of the absolute differential values as given by the following Equation
MAX(EDGE)=MAX[Adv,Adh,Adr,Adl]
MIN(EDGE)=MIN[Adv,Adh,Adr,Adl]
DE=|MAX(EDGE)−MIN(EDGE)|;
comparing an absolute value DE of a value obtained by subtracting the minimum value MIN(EDGE) from the maximum value MAX(EDGE) with a predetermined threshold value; and
determining that this region of the image is the edge region when the absolute value DE is larger than the predetermined threshold value.

10. A method for removing noise, the method comprising:
(a) determining a target region to be processed using a mask filter with respect to an image of a front side of a vehicle and calculating a brightness value of a target pixel within the mask filter;
(b) calculating absolute differential values between the target pixel and surrounding pixels within the mask filter and then, calculating the sum Adv of the absolute differential values in a vertical direction, the sum Adh of the absolute differential values in a horizontal direction, the sum Adr of the absolute differential values in a diagonal direction from the upper right to the lower left, and the sum Adl of the absolute differential values in a diagonal direction from the upper left to the lower right, as given by the following Equation:
Adv=|P11−P01|+|P11−P21|

Adh=|P11−P10|+|P11−P12|

Adr=|P11−P02|+|P11−P20|

Adl=|P11−P00|+|P11−P22|

with respect to all of the brightness value regions calculated at step (a);
(c) detecting a homogeneous region within the image using the sums Adv, Adh, Adr, and Adl of the absolute differential values;
(d) comparing the brightness value of the target pixel with a first predetermined threshold value to detect a dark region within a region of the image detected as the homogeneous region when the homogeneous region is detected at step (c);
(e) comparing the brightness value of the target pixel with a second threshold value to detect an intermediate region or a bright region within a region of the image detected as the homogeneous region when the dark region is not detected at step (d); and
(f) conducting filtering by applying coefficient values of a low pass filter having a weight to the target pixel with respect to a region of the image detected as the bright region.

11. The method according to claim 10, further comprising conducting filtering by applying the coefficient values of the low pass filter having a weight higher than that of the bright region with respect to a region of the image detected as the intermediate region at step (e).

12. The method according to claim 10, further comprising conducting filtering by applying the coefficient values of the low pass filter having a weight higher than that of the intermediate region with respect to a region of the image detected as the dark region at step (d).

13. The method according to claim 10, wherein the detecting of the homogeneous region includes:
comparing the sums Adv, Adh, Adr, and Adl of the absolute differential values with a predetermined threshold value; and
determining that this region of the image is the homogeneous region when all of the sums Adv, Adh, Adr, and Adl of the absolute differential values are smaller than the predetermined threshold value.

14. A method for removing noise, the method comprising:
(a) determining a target region to be processed using a mask filter with respect to an image of a front side of a vehicle and calculating a brightness value of a target pixel within the mask filter;
(b) calculating absolute differential values between the target pixel and surrounding pixels within the mask filter and then, calculating the sum Adv of the absolute differential values in a vertical direction, the sum Adh of the absolute differential values in a horizontal direction, the sum Adr of the absolute differential values in a diagonal direction from the upper right to the lower left, and the sum Adl of the absolute differential values in a diagonal direction from the upper left to the lower right, as given by the following Equation:
Adv=|P11−P01|+|P11−P21|

Adh=|P11−P10|+|P11−P12|

Adr=|P11−P02|+|P11−P20|

Adl=|P11−P00|+|P11−P22|

with respect to all of the brightness value regions calculated at step (a);
(c) detecting a homogeneous region within the image using the sums Adv, Adh, Adr, and Adl of the absolute differential values;
(d) detecting an edge region within the image using the sums Adv, Adh, Adr, and Adl of the absolute differential values when the homogeneous region is not detected at step (c);
(e) detecting a point noise region or a texture region within the image using the sums Adv, Adh, Adr, and Adl of the absolute differential values when the edge region is not detected at step (d);
(f) comparing the brightness value of the target pixel with a second predetermined threshold value to detect an intermediate region or a bright region within a region of the image detected as the texture region when the texture region is detected; and
(g) conducting filtering by applying coefficient values of a low pass filter uniformly assigned to the target pixel and surrounding pixels with respect to a region of the image detected as the bright region.

15. The method according to claim 14, further comprising filtering by applying the coefficient values of the low pass filter uniformly assigned to the target pixel and surrounding pixels and applying coefficient values of a low pass filter having a weight to the target pixel with respect to a region of the image detected as the intermediate region at step (f).

16. The method according to claim 14, further comprising conducting filtering by applying the coefficient values of the low pass filter having a weight to the target pixel with respect to a region of the image detected as the point noise region at step (e).

17. The method according to claim 14, wherein the detecting of the point noise region includes:
comparing the sums Adv, Adh, Adr, and Adl of the absolute differential values with a predetermined threshold value; and
determining that this region of the image is the point noise region when all of the sums Adv, Adh, Adr, and Adl of the absolute differential values are larger than the predetermined threshold value.

18. The method according to claim 14, wherein the detecting of the textual region includes:
comparing the sums Adv, Adh, Adr, and Adl of the absolute differential values with a predetermined threshold value; and
determining that this region of the image is the texture region when even any one of the sums Adv, Adh, Adr, and Adl of the absolute differential values is smaller than the predetermined threshold value.

19. A method for removing noise, the method comprising:
(a) determining a target region to be processed using a mask filter with respect to an image of a front side of a vehicle and calculating a brightness value of a target pixel within the mask filter;
(b) calculating absolute differential values between the target pixel and surrounding pixels within the mask filter and then, calculating the sum Adv of the absolute differential values in a vertical direction, the sum Adh of the absolute differential values in a horizontal direction, the sum Adr of the absolute differential values in a diagonal direction from the upper right to the lower left, and the sum Adl of the absolute differential values in a diagonal direction from the upper left to the lower right, as given by the following Equation:
Adv=|P11−P01|+|P11−P21|

Adh=|P11−P10|+|P11−P12|

Adr=|P11−P02|+|P11−P20|

Adl=|P11−P00|+|P11−P22|

with respect to all of the brightness value regions calculated at step (a);
(c) detecting a homogeneous region within the image using the sums Adv, Adh, Adr, and Adl of the absolute differential values;
(d) detecting an edge region within the image using the sums Adv, Adh, Adr, and Adl of the absolute differential values when the homogeneous region is not detected at step (c);
(e) determining a direction of edge components using the sums Adv, Adh, Adr, and Adl of the absolute differential values when the edge region is detected at step (d);
(f) detecting whether the edge components continuously exist in the determined direction when the direction of the edge components is determined;
(g) comparing the brightness value of the target pixel with a second predetermined threshold value to detect an intermediate region or a bright region within the image in which the edge region is detected when it is detected that the edge components continuously exist at step (f); and
(h) conducting filtering by applying coefficient values of a low pass filer having a weight to pixels positioned in the direction in which the edge components exist with respect to a region of the image detected as the bright region.

20. The method according to claim 19, further comprising conducting filtering by applying the coefficient values of the low pass filter having a weight to the pixels positioned in the direction in which the edge components exist and the target pixel with respect to a region of the image detected as the intermediate region at step (g).

21. The method according to claim 19, further comprising conducting filtering by applying the coefficient values of the low pass filter having a weight to the pixels in which the edge components exist with respect to a region of the image detected that the edge components do not continuously exist at step (f).

22. The method according to claim 19, wherein the determining of the direction of the edge components includes:
calculating an absolute value Dvh of a value obtained by subtracting Adh from Adv and an absolute value Drl of a value obtained by subtracting Adl from Adr;
comparing Dvh with Dvl and comparing Adv with Adh or Adr with Adl according to the comparison result;
comparing Adv with Adh when Dvh is larger than Dvl to determine that the edge components exist in the horizontal direction when Adv is larger than Adh and determine that the edge components exist in the vertical direction when Adv is smaller than Adh; and
comparing Adr with Adl when Drl value is larger than Dvh to determine that the edge components exist in the diagonal direction from the upper right to the lower left when Adr is larger than Adl and determine that the edge components exist in the diagonal direction from the upper left to the lower right when Adr is smaller than Adl, as given by the following Equation:
Dvh=|Adv−Adh|,Drl=|Adr−Adl|

if(Dvh>Drl)&&(Adv>Adh)≅Horizontal Edge
sdv_{—}1=|P10−P00|+|P10−P20|

sdv_{—}2=|P12−P02|+|P12−P22|

if(Dvh>Drl)&&(Adh>Adv)≅Vertical Edge
sdh_{—}1=|P01−P00|+|P01−P02|

sdh_{—}2=|P21−P20|+|P21−P22|

if(Drl>Dvh)&&(Adr>Adl)≅Left Diagonal Edge
sdr_{—}1=|P00−P01|+|P00−P10|

sdr_{—}2=|P22−P12|+|P22−P21|

if(Drl>Dvh)&&(Adl>Adr)≅Right Diagonal Edge
sdl_{—}1=|P02−P01|+|P02−P12|

sdl_{—}2=|P20−P10|+|P20−P21|

23. The method according to claim 19, wherein the detecting of whether the edge components continuously exist in the determined direction includes:
calculating the absolute differential values between two surrounding pixels in the vicinity of a center pixel positioned in the direction determined that the edge components exist at step (e) and surrounding pixels adjacent to the two surrounding pixels and summing the calculated absolute differential values to calculate sdv_1 and sdv_2, sdh_1 and sdh_2, sdr_1 and sdr_2, or sdl_1 and sdl_2;
comparing sdv_1 and sdv_2, sdh_1 and sdh_2, sdr_1 and sdr_2, or sdl_1 and sdl_2 with the predetermined threshold value; and
determining that the edge components continuously exist in the determined direction when all of sdv_1 and sdv_2, sdh_1 and sdh_2, sdr_1 and sdr_2, or sdl_1 and sdl_2 are larger than the threshold value, as given by the following Equation:
Dvh=|Adv−Adh|,Drl=|Adr−Adl|

if(Dvh>Drl)&&(Adv>Adh)≅Horizontal Edge
sdv_{—}1=|P10−P00|+|P10−P20|

sdv_{—}2=|P12−P02|+|P12−P22|

if(Dvh>Drl)&&(Adh>Adv)≅Vertical Edge
sdh_{—}1=|P01−P00|+|P01−P02|

sdh_{—}2=|P21−P20|+|P21−P22|

if(Drl>Dvh)&&(Adr>Adl)≅Left Diagonal Edge
sdr_{—}1=|P00−P01|+|P00−P10|

sdr_{—}2=|P22−P12|+|P22−P21|

if(Drl>Dvh)&&(Adl>Adr)≅Right Diagonal Edge
sdl_{—}1=|P02−P01|+|P02−P12|

sdl_{—}2=|P20−P10|+|P20−P21|

24. A night vision system displaying a night image around a vehicle sensed from a camera module on a display, the night vision system comprising:
a first noise removing unit removing noise by filtering compositions serving as the noise in an image signal output from an image sensor;
a brightness improving unit improving a brightness value of the image in which the noise components are removed by the first noise removing unit;
a second noise removing unit removing the noise by filtering components serving as the noise in the image in which the brightness value is improved by the brightness improving unit; and
a signal processing unit processing the image signal in which the brightness value is improved and the noise components are removed and outputting the image signal to the display.

25. The night vision system according to claim 24, wherein the first noise removing unit performs the method according to any one of claims 1 to 9.

26. The night vision system according to claim 24, wherein the second noise removing unit performs the method according to any one of claims 1 to 4 or claims 10 to 23.

27. The night vision system according to claim 24, wherein the first noise removing unit performs the method according to any one of claims 1 to 9, and the second noise removing unit performs the method according to any one of claims 1 to 4 or claims 10 to 23.
